(19) United States
(12) Patent Application Publication
(10) Pub. No.: US 2006/0144818 A1
(43) Pub. Date: Jul. 6, 2006

(54) System for detecting film quality variation and method using the same

(75) Inventor: Jae Soung Kim, Goyang-si (KR)

Correspondence Address: MCKENNA LONG & ALDRIDGE LLP;Song K. Jung, 1900 K Street, N.W., Washington, DC, 20006, US

(73) Assignee: DongbuAnam Semiconductor Inc., Seoul (KR)

(21) Appl. No.: 11/319,594

(22) Filed: Dec. 29, 2005

(30) Foreign Application Priority Data
Dec. 30, 2004 (KR) 10-2004-0116524

(51) Int. Cl. G01L 21/30; C23F 1/00

(52) U.S. Cl. 216/59; 156/345.25

(57) ABSTRACT

A system includes a throttle valve moving in response to a pressure present in a vacuum pump line for controlling the pressure of the vacuum pump line based on the movement of the throttle valve; a monometer for detecting the movement of the throttle valve and outputting movement data indicative of the movement of the throttle valve; and a proportional integral derivative controller for generating feedback information based on the movement data output from the monometer.

### CROSS-REFERENCE TO RELATED APPLICATION

This application claims the benefit of Korean Patent Application No. 10-2004-0116524, filed on Dec. 30, 2004, which is hereby incorporated by reference as if fully set forth herein.

### BACKGROUND OF THE INVENTION

1. Field of the Invention

The present invention relates to a semiconductor manufacturing apparatus, and more particularly, to a system and method for detecting variation in film quality, during a cleaning process as well as during dry etching, on the basis of the movement of a throttle valve of a dry etching apparatus.

2. Discussion of the Related Art

FIG. 1 shows the basic structure of a dry etching apparatus of a conventional semiconductor manufacturing apparatus. As shown in FIG. 1, a first waveguide 2 having a rectangular cross section and communicating with a second waveguide 4 having a large circular configuration disposed within the windings of a coil 3. The second waveguide 2 can have the configuration of a quartz bell jar. The first and second waveguides 2, 4 form an integral body for directing microwaves generated by a magnetron 1, which is coupled to the inlet of the first waveguide, at a process wafer 7 received in the mouth of the second waveguide where a discharge tube 5 forms a gas reaction chamber 6, which is housed within the second waveguide. One side of the discharge tube 5 communicates with a gas introduction tube 11 and an exhaust pipe 10 at a lower portion of the discharge tube integrally formed with a support frame 15. A base member 16 connected to a high-frequency (HF) power source 9 extends up through the center of the support frame 15 and has a seating surface at its upper end for receiving the process wafer 7, which is thus disposed within the gas reaction chamber 6. Plasma levels in the second waveguide 4 are monitored using a plasma monitor 8.

In the dry etching apparatus discussed above, the magnetron 1 generates microwaves of about 2.2 GHz, which enter the first waveguide 2 and proceed to the second waveguide 4. A cyclotron movement of electrons in the gas reaction chamber 6 results from the synergism between the electromagnetic field of the microwaves and a perpendicular magnetic field generated by the coil 3. The electrons react with gas introduced from the gas introduction tube 11 at a low pressure to obtain high-density and uniform plasma. Dry etching is performed as the plasma reaches the process wafer 7. The directionality of ions, or radicals, in the plasma moving toward the process wafer 7 is enhanced by the high-frequency power applied to the base member 16, i.e., below the process wafer.

Thus, a high power etching apparatus can control the energy of ions incident on the wafer independently of the generation of plasma. Furthermore, contamination can be prevented by avoiding the use of an upper power source, and high-density etching is realized through the use of a coil wound around the gas reaction chamber.

Meanwhile, it is important to monitor the variation in film quality during the dry etching process, particularly when etching only a specific layer among multiple layers so that damage can be minimized. For example, film quality variation may be monitored using a specific wavelength generated from the plasma and an interference wavelength to indirectly monitor the thickness of the film. Such methods, however, are costly and involve restrictive installations inside the chamber, thereby impeding the etching process. Moreover, variations in accumulating films cannot be monitored inside the chamber during a cleaning process, thereby precluding an effective management of process time.

### SUMMARY OF THE INVENTION

Accordingly, the present invention is directed to a system for detecting film quality variation and a method using the same that substantially obviates one or more disclosed or undisclosed problems or issues that may be due to limitations and disadvantages of the related art.

The present invention may include a system and method for detecting variations in film quality on the basis of movement of a throttle valve of a dry etching apparatus.

Additional advantages, objects, and features of the invention will be set forth in part in the description which follows and in part will become apparent to those having ordinary skill in the art upon examination of the following. These and other advantages of the invention may be realized and attained by the structure particularly pointed out in the written description and claims hereof as well as the appended drawings.

To achieve these and other advantages in accordance with the invention, as embodied and broadly described herein, a system for detecting film quality variation comprising a throttle valve moving in response to a pressure present in a vacuum pump line that controls the pressure of the vacuum pump line based on the movement of the throttle valve; a monometer for detecting the movement of the throttle valve and outputting movement data indicative of the movement of the throttle valve; and a proportional integral derivative controller for generating feedback information based on the movement data output from the monometer.

According to another aspect of the present invention, a method of detecting film quality variation comprises generating a pressure in a vacuum pump line that moves a throttle valve; detecting the movement of the throttle valve to output movement data indicative of the detected movement of the throttle valve; generating feedback information based on the movement data output; and controlling the pressure of the vacuum pump line based on the feedback information.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and illustrate embodiments of the invention and together with the description serve to explain the principle of the invention. In the drawings:

FIG. 1 is a schematic diagram of a conventional semiconductor manufacturing apparatus for performing dry etching;

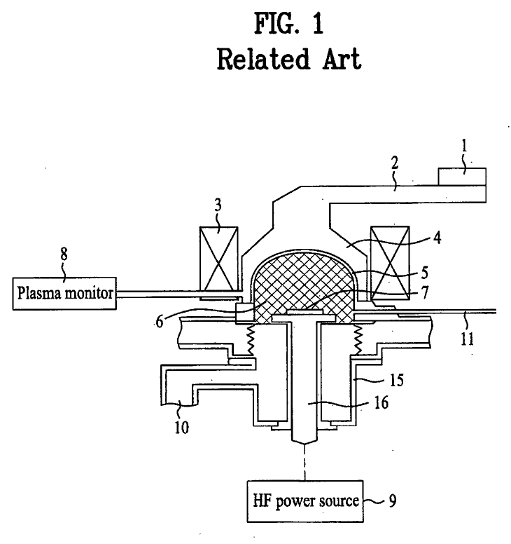

FIG. 2 is a block diagram of a system for detecting variation in film quality during a dry etching process according to an exemplary embodiment of the present invention; and

FIG. 3 is a graph showing data on the movement of a throttle valve during the dry etching process according to the present invention.

### DETAILED DESCRIPTION OF THE INVENTION

Reference will now be made in detail to exemplary embodiments of the present invention, examples of which are illustrated in the accompanying drawings. Wherever possible, like reference designations will be used throughout the drawings to refer to the same or similar parts.

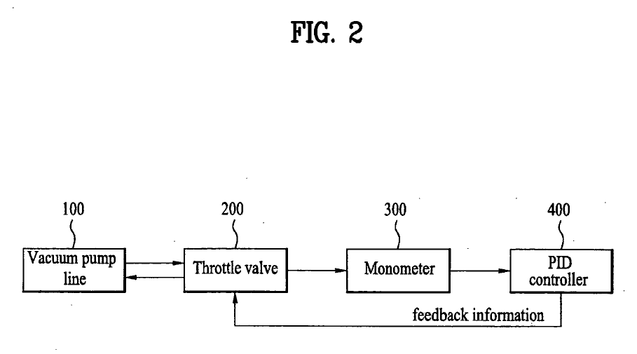

Referring to FIG. 2, illustrating a system for detecting film quality variation according to one embodiment of the present invention, a vacuum pump line 100 generates pressure during dry etching. A throttle valve 200 moves in response to the pressure of the vacuum pump line 100 and controls the pressure of the vacuum pump line 100. A monometer 300 measures the movement of the throttle valve 200 and outputs movement data indicative of the movement of the throttle valve to a proportional integral derivative (PID) controller 400. The PID controller 400 outputs the feedback information to the throttle valve 200. the throttle valve 200 controls the pressure of the vacuum pump line 100 based on the feedback information.

The controller is an amplifier with a constant gain, whereby an output operational signal is proportional to the product of an input of the controller and a proportional constant to result in “proportional control.” Meanwhile, a linear continuous value controller may employ a differentiation and integration of the input signal with respect to time in addition to a proportional operation via addition and subtraction or a simple algebraic operation. The PID controller 400 is a controller capable of providing the functions of proportional operation, differentiation, and integration.

In the etching apparatus, the throttle valve connected to the vacuum pump line moves and the pressure is carefully controlled to maintain a predetermined level. It should be noted that pressure is typically the most important parameter among the process conditions. When the throttle valve moves, data collected by the monometer is fed back to the throttle valve via the PID controller. Meanwhile, the amount of byproduct generated during a dry etching process, i.e., upon completion of the etching of a film, varies depending on film characteristics, the gas ratio, and the applied power and pressure. The total amount of byproduct can vary drastically. Therefore, the variation in byproduct generated during the dry etching process appears as a movement of the throttle valve controlling the pressure, rather than as a variation in pressure, and for a vacuum of 10 mT or less a significant degree of movement can be detected, even with very minute variations in byproduct.

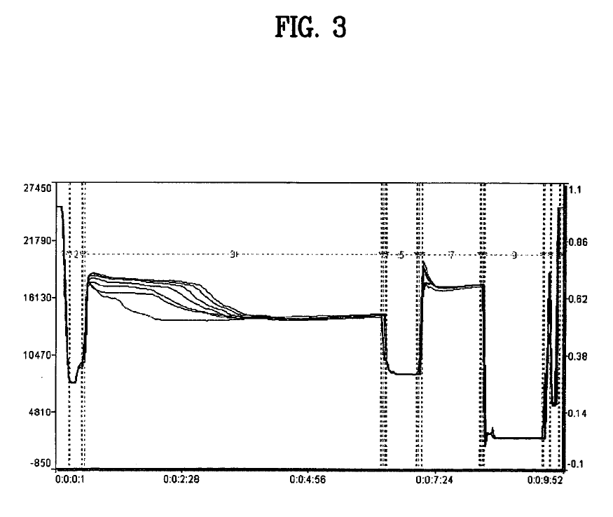

FIG. 3 showing data on the movement in the throttle valve during the dry etching process according to the present invention. Great variations of the throttle valve are detected with respect to a sample series of processes. Specifically, when the amount of byproduct varies during the dry etching process, the variation appears as a movement of the throttle valve. Here, the x axis represents the variation of time, and the y axis represents the variation of pressure.

The present invention can enable effective process control without an additional investment in equipment by monitoring the valve step parameter of the conventional device. In addition, process time can be effectively managed by monitoring variations in an accumulated film inside the chamber during a cleaning process.

It will be apparent to those skilled in the art that various modifications can be made in the present invention without departing from the spirit or scope of the invention. Thus, it is intended that the present invention covers such modifications provided they come within the scope of the appended claims and their equivalents.

What is claimed is:

1. A system for detecting film quality variation, the system comprising:
a throttle valve adapted to move in response to a pressure present in a vacuum pump line, wherein the throttle valve controls the pressure of the vacuum pump line based on the movement of said throttle valve;
a monometer for detecting the movement of said throttle valve and outputting movement data indicative of the movement of said throttle valve; and
a controller for generating feedback information based on the movement data output from said monometer.

2. The system according to claim 1, wherein said throttle valve receives the feedback information generated by said controller to determine the movement of said throttle valve.

3. The system according to claim 1, wherein said controller is a proportional integral derivative controller.

4. The system according to claim 1, wherein the pressure of the vacuum pump line is generated during a dry etching process.

5. The system according to claim 1, wherein the pressure of the vacuum pump line is not more than 10 mT.

6. The system according to claim 1, further comprising a dry etching apparatus.

7. The system according to claim 6, wherein said dry etching apparatus comprises:
a magnetron for generating microwaves in accordance with an electromagnetic field;
a body for directing the microwaves at a process wafer, said body including a first waveguide coupled to said magnetron and communicating with a second waveguide for receiving the process wafer;
a coil wound around the second waveguide for generating a magnetic field perpendicular to the electromagnetic field of the microwaves;
a gas reaction chamber housed within the second waveguide;
a base member having a seating surface for receiving the process wafer within the reaction chamber; and
a high-frequency power source connected to said base member.

8. The system according to claim 7, wherein the process wafer undergoes a dry etching process and wherein a film quality of the process wafer is detected according to the movement of said throttle valve.

9. The system according to claim 7, wherein the pressure of the vacuum pump line is generated during a cleaning process performed inside said gas reaction chamber.

10. A system for detecting film quality variation, the system comprising:
a vacuum pump line generating a pressure during dry etching of a process wafer;
a throttle valve moving in response to a pressure present in said vacuum pump line for controlling the pressure of the vacuum pump line based on the movement of said throttle valve;
a monometer for detecting the movement of said throttle valve and outputting movement data indicative of the movement of said throttle valve; and
a proportional integral derivative controller for generating feedback information based on the movement data output from said monometer, the generated feedback information being used to determine the movement of said throttle valve.

11. A method of detecting film quality variation, the method comprising:
generating a pressure in a vacuum pump line, the pressure moving a throttle valve;
detecting the movement of the throttle valve to output movement data indicative of the detected movement of the throttle valve;
generating feedback information based on the movement data output; and
controlling the pressure of the vacuum pump line based on the feedback information.

12. The method according to claim 11, wherein the feedback information is generated by a proportional integral derivative controller.

13. The method according to claim 11, wherein the movement of the throttle valve is detected using a monometer.

14. The method according to claim 11, wherein the pressure of the vacuum pump line is not more than 10 mT.

15. The method according to claim 11, wherein the pressure in the vacuum pump line is generated during a dry etching process performed on a process wafer.

16. The method according to claim 11, wherein the pressure in the vacuum pump line is generated during a cleaning process performed within a gas reaction chamber performing a dry etching process.
